(19) United States
(12) Patent Application Publication
(10) Pub. No.: US 2011/0096808 A1
(43) Pub. Date: Apr. 28, 2011

(54) Temperature detecting device for motion guide apparatus

(75) Inventors: Yih Chyun Hwang, Taichung (TW); Fu-Chun Huang, Taichung (TW)

(73) Assignee: Hiwin Technologies Corp.

(21) Appl. No.: 12/589,708

(22) Filed: Oct. 27, 2009

(51) Int. Cl. G01K 1/00; F16H 25/22; G01K 7/00; G01K 7/02

(52) U.S. Cl. 374/141; 74/89.23; 374/E01.001; 374/183; 374/E07.028; 374/E07.004; 374/179

(57) ABSTRACT

A motion guide device includes a ball nut attached onto a shaft and having helical grooves for receiving a number of ball bearing elements, and having a compartment form receiving a temperature detecting device which detects a temperature of the ball nut for preventing the ball nut from overheating, an indicating device is coupled to the temperature detecting device for generating an indicating signal when the temperature detecting device has sensed or detected that the temperature of the ball nut or the screw shaft is higher than the predetermined temperature or value, and the user may then stop working to find out what problems have been happened and thus to prevent the motion guide device from overheating.

### BACKGROUND OF THE INVENTION

1. Field of the Invention

The present invention relates to a motion guide apparatus, such as a linear motion guide apparatus or a ball screw device, and more particularly to a motion guide apparatus including two movable members or a screw shaft and a ball nut movable relative to each other, and a temperature detecting device attached to one of the two movable members for detecting the temperature of the motion guide apparatus and for preventing the motion guide apparatus from overheating.

2. Description of the Prior Art

Typical working machines, such as rolling mills comprise a roll bearing engaged in a work roll of a roll stand for directly measuring the temperature at the bearing without detaching connecting lines during changing of rolls.

For example, U.S. Pat. No. 4,939,920 to Stahl discloses one of the typical monitoring devices for roll bearings in rolling mills and comprising a monitoring device installed in the chock of the work roll of a roll stand, and resided in a cartridge or in a thermal limit value pickup in contact with the roll bearing.

However, the cartridge may have a good chance to be broken or damaged after use, but may not be easily and quickly changed or replaced with the other new ones because the cartridge is deeply received or engaged in the monitoring device and may not be easily disengaged from the thermal limit value pickup or device and thus may not be easily repaired.

Typical motion guide apparatuses, such as the linear motion guide apparatuses or the ball screw devices comprise two movable members rotatable or movable relative to each other, and a number of ball bearing elements disposed between the two movable members for facilitating the sliding movement between the two movable members and may generate a great heat when the two movable members are rotated relative to each other in a great rotational speed.

However, no temperature detecting devices have been developed and provided and attached to one of the two movable members for detecting the temperature of the motion guide apparatus, and a great heat may be generated between the movable members and the ball bearing elements, such that the users may not aware the temperature of the movable members and may not prevent the motion guide apparatus from overheating.

The present invention has arisen to mitigate and/or obviate the afore-described disadvantages of the conventional motion guide apparatuses.

### SUMMARY OF THE INVENTION

The primary objective of the present invention is to provide a motion guide apparatus including two movable members movable relative to each other, and a temperature detecting device attached to one of the two movable members for detecting the temperature of the motion guide apparatus and for preventing the motion guide apparatus from overheating.

In accordance with one aspect of the invention, there is provided a motion guide apparatus comprising an elongated shaft including a helical groove formed on an outer peripheral surface thereof, a ball nut movably attached onto the elongated shaft, and including a bore formed therein for receiving the elongated shaft, and including a helical groove formed therein, and including a compartment formed therein, a deflecting device engaged with the ball nut and communicative with the helical groove of the ball nut for forming an endless ball guiding passage between the ball nut and the elongated shaft, a number of ball bearing elements received and engaged with the endless ball guiding passage and engaged between the elongated shaft and the ball nut, and a temperature detecting device engaged into the compartment of the ball nut for detecting a temperature of the ball nut and for preventing the ball nut from overheating.

The temperature detecting device includes an indicating device coupled to the temperature detecting device for generating an indicating signal when the temperature detecting device has sensed that the temperature of the ball nut and/or the screw shaft is higher than the predetermined temperature or value, and the user may then stop working to find out what problems have been happened and thus to prevent the motion guide apparatus from overheating.

The temperature detecting device includes a power source electrically coupled to the temperature detecting device and the indicating device for energizing the temperature detecting device and the indicating device.

The temperature detecting device includes a resistor electrically coupled in parallel to the indicating device for preventing the indicating device from being loaded and for preventing the indicating device from being damaged and for increasing the working life of the indicating device.

The temperature detecting device includes a heat conductive member disposed between the ball nut and the temperature detecting device for transmitting or conducting the heat from the ball nut to the temperature detecting device or between the ball nut and the temperature detecting device and for facilitating the temperature detecting effect or function of the temperature detecting device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a motion guide apparatus in accordance with the present invention;

FIG. 2 is a partial cross sectional view of the motion guide apparatus;

FIG. 3 is another partial cross sectional view similar to FIG. 2 illustrating the other arrangement of the motion guide apparatus;

FIG. 4 is a plan schematic view illustrating an electric circuit of the motion guide apparatus; and

FIG. 5 is a plan schematic view similar to FIG. 4 illustrating the further arrangement of the electric circuit of the motion guide apparatus.

### DETAILED DESCRIPTION OF THE PREFERRED EMBODIMENT

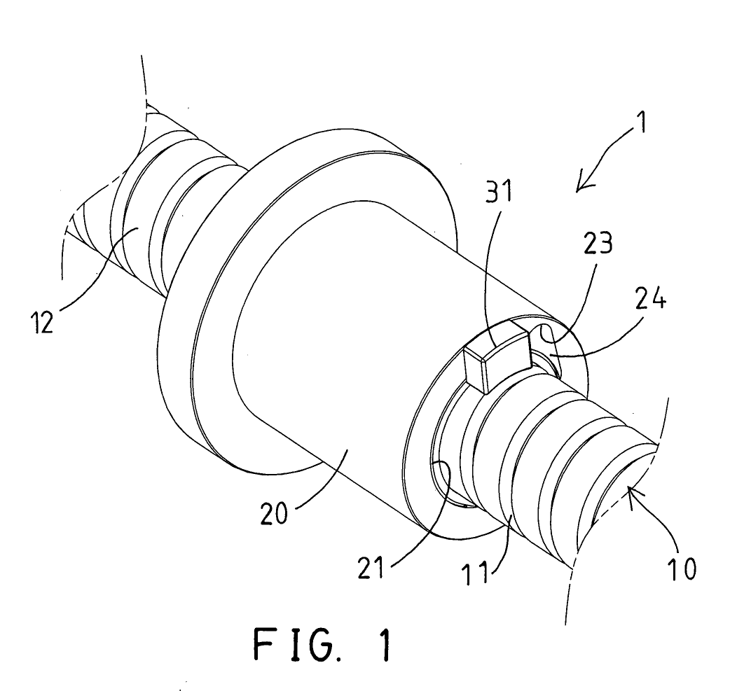

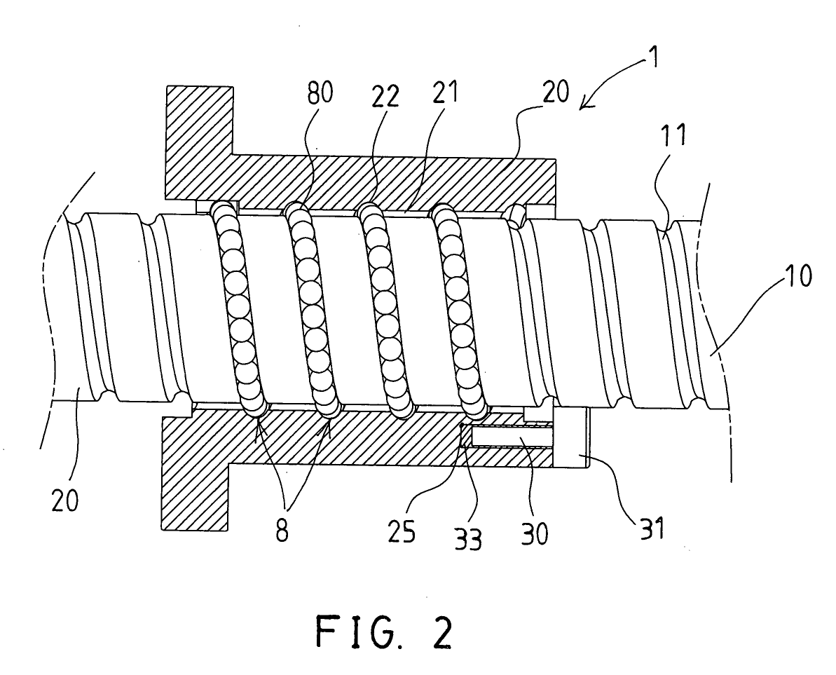

Referring to the drawings, and initially to FIGS. 1-2, a motion guide apparatus 1 in accordance with the present invention, such as a ball screw device 1, comprises an elongated bolt or screw shaft 10 including a number of helical threaded portions or grooves 11 formed on the outer peripheral portion thereof, or formed in the outer peripheral surface 12 thereof, and a movable member, such as a ball nut 20 including a screw hole or bore 21 formed therein for receiving or engaging with the elongated screw shaft 10, and the screw hole or bore 21 of the ball nut 20 is formed or defined by a number of helical threaded portions or grooves 22 for threading or engaging or aligning with the helical threaded portions or grooves 11 of the screw shaft 10, and for forming an endless multiple-turn, helical raceway or ball guiding passage 8 between the screw shaft 10 and the ball nut 20, and for slidably receiving a number of ball bearing elements 80 and for facilitating the sliding or rotational movement between the two movable members 10, 20 or the screw shaft 10 and the ball nut 20.

The ball nut 20 includes a returning channel (not shown) longitudinally or axially formed in the outer peripheral portion thereof, and intersecting or communicating with helical threaded portions or grooves 22 or the ball guiding passage 8, and includes two depressions 23 formed therein (FIG. 1), such as formed in the two side or end portions of the ball nut 20, and arranged and intersected or communicated with the returning channel of the ball nut 20, and the depressions 23 the ball nut 20 are ach provided for receiving or attaching or engaging with a deflecting device 24 which is engaged with or attached or mounted or secured to the ball nut 20 with latches or fasteners (not shown) for guiding or deflecting or returning the ball bearing elements 80 to move cyclically in the endless multiple-turn, helical raceway or ball guiding passage 8 of the ball screw device 1. The above-described structure is typical and will not be described in further details.

The ball nut 20 further includes a recess or space or compartment 25 formed therein and arranged or located close to, but not communicative with the helical threaded portions or grooves 22 or the ball guiding passage 8, and a temperature detecting device 30 is attached to one of the two movable members 20, such as engaged into the compartment 25 of the ball nut 20, and may be contacted with the ball nut 20 or non-contacted or spaced from the ball nut 20, and may be selected from a thermo-couple, or a thermistor for detecting the temperature of the ball nut 20 and/or the screw shaft 10 of the motion guide apparatus 1 and for preventing the motion guide apparatus 1 from overheating. For example, when the temperature detecting device 30 has sensed or detected that the temperature of the ball nut 20 and/or the screw shaft 10 is higher than a predetermined temperature or value, the user may stop working to find out what problems have been happened and thus to prevent the motion guide apparatus 1 from overheating.

As shown in FIGS. 1-2 and 4, the temperature detecting device 30 includes a buzzer or light device or other indicating device 31 coupled to the temperature detecting device 30 for generating a warning sound, a warning light or the other indicating signals when the temperature detecting device 30 has sensed or detected that the temperature of the ball nut 20 and/or the screw shaft 10 is higher than the predetermined temperature or value, and includes an energy or cells or batteries or power source 32 electrically coupled to the temperature detecting device 30 and/or the indicating device 31 for energizing the temperature detecting device 30 and/or the indicating device 31. The indicating device 31 may be attached or mounted or secured to the ball nut 20 with latches or fasteners (not shown) or the like.

As shown in FIG. 2, the temperature detecting device 30 may further include a heat transmitting or conductive film or membrane or member 33 provided and engaged onto the outer peripheral portion of the temperature detecting device 30, or disposed between the ball nut 20 and the temperature detecting device 30 for transmitting or conducting the heat from the ball nut 20 to the temperature detecting device 30 or between the ball nut 20 and the temperature detecting device 30 and for facilitating the temperature sensing or detecting effect of the temperature detecting device 30, in which the heat transmitting or conductive film or membrane or member 33 may be contacted with the ball nut 20 or non-contacted or spaced from the ball nut 20 and may be made of the materials selected from silver powder, copper powder, aluminum powder, gold powder, iron powder, silicon oil and magnesium oxide compound, silicon oil and silver powder compound, silicon oil and copper powder compound, or silicon oil and aluminum oxide or zinc oxide or boron nitride compound, or the combination thereof.

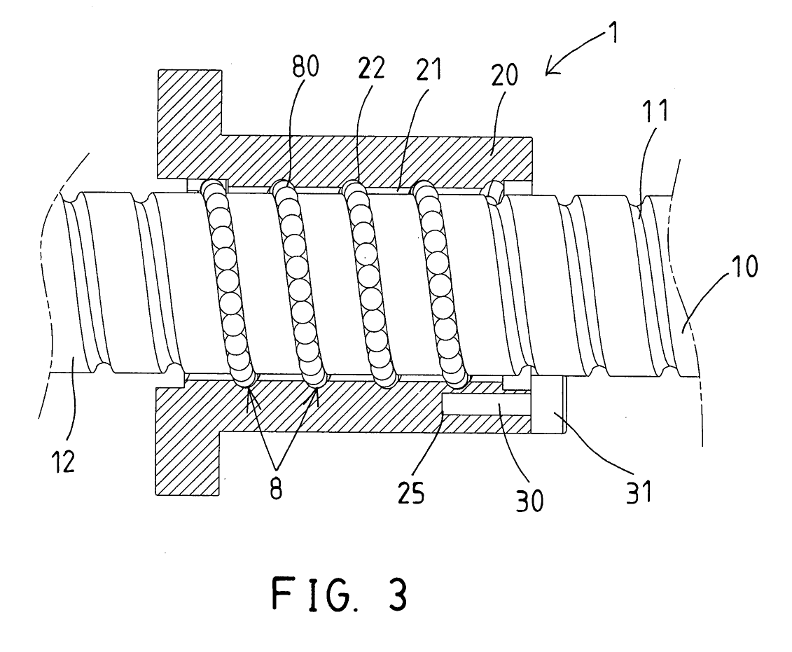

Alternatively, as shown in FIG. 3, without the heat transmitting or conductive film or membrane or member 33, the temperature detecting device 30 may be directly engaged into the compartment 25 of the ball nut 20.

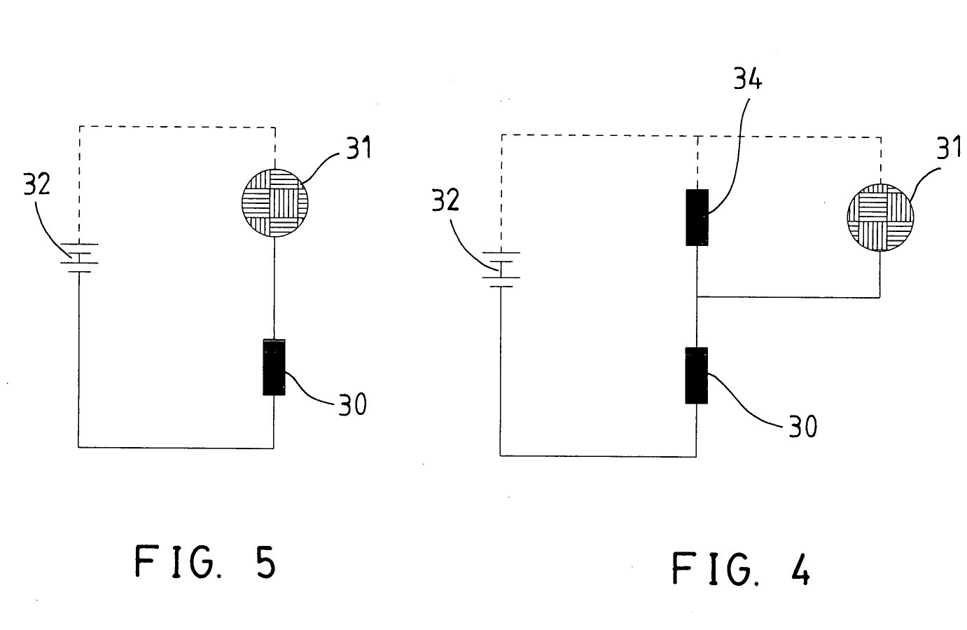

As shown in FIG. 4, the temperature detecting device 30 may further include a resistor 34 electrically coupled in parallel to the indicating device 31 for preventing the indicating device 31 from being loaded or for lowering the voltage applied to the indicating device 31, and for preventing the indicating device 31 from being damaged and for increasing the working life of the indicating device 31. In operation, the resistance of the resistor 34 will be decreased or lowered when the temperature detecting device 30 has sensed or detected that the temperature of the ball nut 20 and/or the screw shaft 10 is higher than the predetermined temperature or value, and the indicating device 31 may then generate the warning sound, the warning light or the other indicating signals. Alternatively, as shown in FIG. 5, the temperature detecting device 30 and the indicating device 31 and the batteries or power source 32 may be coupled in series together for forming a circuit without the resistor 34.

Accordingly, the motion guide apparatus in accordance with the present invention includes two movable members movable relative to each other, and a temperature detecting device attached to one of the two movable members for detecting the temperature of the motion guide apparatus and for preventing the motion guide apparatus from overheating.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A motion guide apparatus comprising:
an elongated shaft including a helical groove formed on an outer peripheral surface thereof,
a ball nut movably attached onto said elongated shaft, and including a bore formed therein for receiving said elongated shaft, and including a helical groove formed therein,
a deflecting device engaged with said ball nut and communicative with said helical groove of said ball nut for forming an endless ball guiding passage between said ball nut and said elongated shaft,
a plurality of ball bearing elements received and engaged with said endless ball guiding passage and engaged between said elongated shaft and said ball nut,
a temperature detecting device attached to said ball nut for detecting a temperature of said ball nut and for preventing said ball nut from overheating, and
a power source and an indicating device coupled to said temperature detecting device for generating an indicating signal when said temperature detecting device has detected that the temperature of either of said ball nut or said shaft is higher than a predetermined value.

2. The motion guide apparatus as claimed in claim 1, wherein said ball nut includes a compartment formed therein, said temperature detecting device is engaged into said compartment of said ball nut.

3. The motion guide apparatus as claimed in claim 2, wherein said temperature detecting device is contacted with said ball nut.

4. The motion guide apparatus as claimed in claim 2, wherein said temperature detecting device is spaced from said ball nut.

5. The motion guide apparatus as claimed in claim 1, wherein said temperature detecting device includes a heat conductive member disposed and engaged onto an outer peripheral portion of said temperature detecting device.

6. The motion guide apparatus as claimed in claim 5, wherein said heat conductive member is contacted with said ball nut.

7. The motion guide apparatus as claimed in claim 5, wherein said heat conductive member is spaced from said ball nut.

8. The motion guide apparatus as claimed in claim 5, wherein said heat conductive member is made of a material selected from silver powder, copper powder, aluminum powder, gold powder, iron powder, silicon oil and magnesium oxide compound, silicon oil and silver powder compound, silicon oil and copper powder compound, or silicon oil and aluminum oxide or zinc oxide or boron nitride compound.

9. The motion guide apparatus as claimed in claim 1, wherein said temperature detecting device includes a resistor electrically coupled in parallel to said indicating device for preventing said indicating device from being loaded.

10. The motion guide apparatus as claimed in claim 1, wherein said temperature detecting device is selected from a thermo-couple.

11. The motion guide apparatus as claimed in claim 1, wherein said temperature detecting device is selected from a thermistor.
